(19) United States
(12) Patent Application Publication
(10) Pub. No.: US 2004/0056442 A1
(43) Pub. Date: Mar. 25, 2004

(54) Baggage scooter

(76) Inventors: Joseph Ostrowski, Miami, FL (US); Robert C. Martinez, Miami, FL (US); Christopher B. Hall, Miami, FL (US)

Correspondence Address: Richard C. Litman, LITMAN LAW OFFICES, LTD., P.O. Box 15035, Arlington, VA, 22215, US

(21) Appl. No.: 10/665,217

(22) Filed: Sep. 22, 2003

Related U.S. Application Data
(60) Provisional application No. 60/412,555, filed on Sep. 23, 2002.

(51) Int. Cl. B62M 1/00

(52) U.S. Cl. 280/87.041

(57) ABSTRACT

A carry-on tote bag that can be ridden, more specifically, a baggage scooter for transporting a carrying case or luggage item, additional items, and/or a person. The baggage scooter has a first plate with a wheel or wheels and a retractable handle for holding a carrying case or luggage item, and a selectively deployable second plate with a wheels or wheels, upon which items can be carried or upon which a person can ride in a standing or other position. The baggage scooter may be used with or without a carrying case or luggage item attached. The baggage scooter may include a driving device for moving the baggage scooter. The baggage scooter may be integrally formed to a baggage item or adapted to carry baggage or other items.

### CROSS-REFERENCE TO RELATED APPLICATION

This application claims the benefit of U.S. Provisional Patent Application Serial No. 60/412,555, filed Sep. 23, 2002.

### BACKGROUND OF THE INVENTION

1. Field of the Invention

The present invention relates to baggage carriers and, more specifically, to a combination luggage scooter comprising a platform with a wheel or wheels and a retractable handle for holding a carrying case or luggage item, and a selectively deployable platform with a wheel or wheels, upon which items can be carried or upon which a person can ride in a standing or other position. In short, it is a carry-on tote bag that can be ridden.

2. Description of Related Art

Numerous inventions have been devised for the purpose of carrying luggage. Some of the more significant advances in the art have centered around the development of a carrying case, luggage item, or platform that eases the effort required to move luggage from one place to another.

The related art describes devices for carrying items either on a base or with in a carrying case or luggage item. However, these devices do not include both a carrying case or luggage item and a means for carrying items not contained in the luggage article, or for carrying a person.

For example, U.S. Patent Publication No. 2002/0023813, issued published in February 2002, describes a luggage article including first rollers, a retractable handle, and selectively deployable second rollers. The second set of rollers supports some of the weight of the luggage article. This device does not provide a platform for carrying items not contained in the luggage article or for carrying a person.

U.S. Patent Publication No. 2002/0027052, published in March 2002, describes a carrying case or luggage item that has a telescoping handle and two wheels as a means to transport the device. The device does not have a platform for carrying items not contained in the luggage article or for carrying a person.

U.S. Patent Publication No. 2001/0015535, published in August 2001, shows a household cart that includes a base for carrying household items. The household cart includes four caster assemblies and a unshaped handle. While this devise can be dismantled and stored in a small space, it does not include a carrying case or luggage item.

U.S. Pat. No. 6,325,189, issued to King et al., describes a two wheeled luggage case that has a luggage area, a telescoping handle, and two wheels as a means to transport the device. The device does not have a platform for carrying items not contained in the luggage article or for carrying a person.

U.S. Pat. No. 6,357,566, issued to Pond, shows a carry-on case that has a base, a connected lid, and a telescoping handle. The device does not have a platform for carrying items not contained in the luggage article or for carrying a person.

U.S. Pat. No. 5,820,146, issued Oct. 13, 1998 to Van Ligten, describes a hand cart which can be used to transport persons and/or luggage. When used to transport a person, the device resembles a scooter with a forwardly extending platform. In different embodiments, either all or a portion of the stepboard may be folded upward when transporting baggage. No storage compartment is shown fixed to the hand cart.

None of the above inventions and patents, taken either singly or in combination, is seen to describe the instant invention as claimed.

### SUMMARY OF THE INVENTION

The present invention provides a baggage scooter for holding a carrying case or luggage item, as well as additional luggage, items, or a person. The invention further provides a baggage item that is integrally secured to a scooter assembly to provide a baggage item that may itself be ridden. The invention is made of lightweight rigid material such as steel, aluminum, plastic, composite material or combinations thereof. The baggage scooter may include a driving means for moving the baggage scooter. It is a carry-on tote bag that can be ridden.

The baggage scooter has a first plate with one or two wheels and a retractable handle for holding a carrying case or luggage item, and a selectively deployable second plate with one or two wheels, upon which additional luggage or other items can be carried or upon which a person can ride in a standing or other position.

In use, the baggage scooter may be used with or without a carrying case or luggage item attached. To use the invention, the baggage scooter can be: 1) carried with the handle retracted and the second plate locked in an upright stored position, 2) pulled or pushed by the handle with the handle in an extended position and the second plate locked in an upright stored position, or 3) pulled or pushed with the handle in an extended position and the second plate in an extended position for use.

Accordingly, it is a principal object of the invention to provide a new baggage scooter upon which items can be carried or upon which a person can ride in a standing or other position.

It is another object of the invention to provide a baggage scooter that reduces the amount of effort required to move baggage, items, or a person from one place to another.

It is a further object of the invention to provided a baggage scooter for holding a carrying case, luggage item, book case, or back pack upon which a person can ride.

Still another further object of the invention is to provide a baggage scooter for holding a carrying case or luggage item upon which additional luggage, items, or a person can be transported.

Another object of the invention is to provide a baggage scooter that can be used by adults and children in a home, business, school, recreational, or other setting.

It is a further object of the invention to provided a baggage scooter that can be used to reduce back pain associated with carrying heavy luggage, back packs, or other items.

It is another object of the invention to provide a baggage scooter that has a selectively expandable second plate that can be expanded to increase the carrying capacity of the second plate.

Another object of the invention is to provide a baggage scooter that can have a power drive upon which a person could ride.

It is still another object of the invention to provide a baggage scooter that is integrally secured to a baggage item to provide a carry-on bag that may itself be ridden.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view showing the invention in use.

FIG. 2 is a perspective view of a first embodiment of the invention.

FIG. 3 is a back view to a first embodiment of the invention in a closed position.

FIG. 4 is a sectional view drawn along lines A-A of FIG. 3, and shows the second plate and first connecting means.

FIG. 5 is a side view of the first embodiment of the locking means with the second plate in an extended position.

FIG. 6 is a view similar to FIG. 5, but showing the second plate in an upright closed position.

FIG. 7 is a perspective view of a braking means attached to the first plate.

FIG. 8 is a perspective view of a braking means attached to the second plate.

FIG. 9 is a rear perspective view of a preferred embodiment of the present invention in the riding position.

FIG. 10 is a rear perspective view of the preferred embodiment of the present invention being moved into the carrying position.

FIG. 11 is a perspective view of a locking device used in the preferred embodiment of the present invention.

Similar reference characters denote corresponding features consistently throughout the attached drawings.

### DETAILED DESCRIPTION OF THE PREFERRED EMBODIMENTS

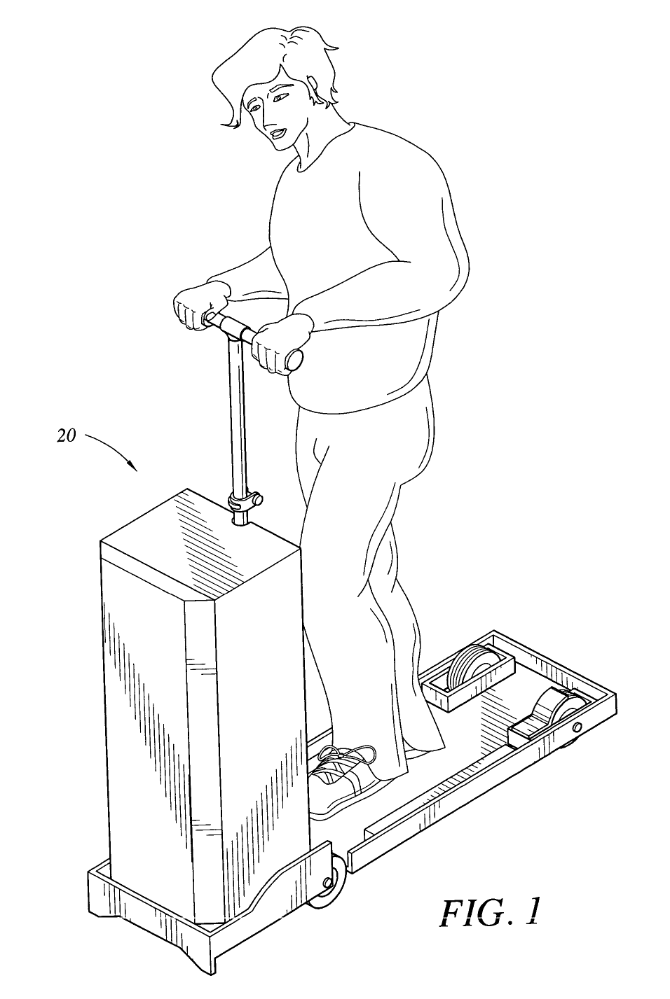

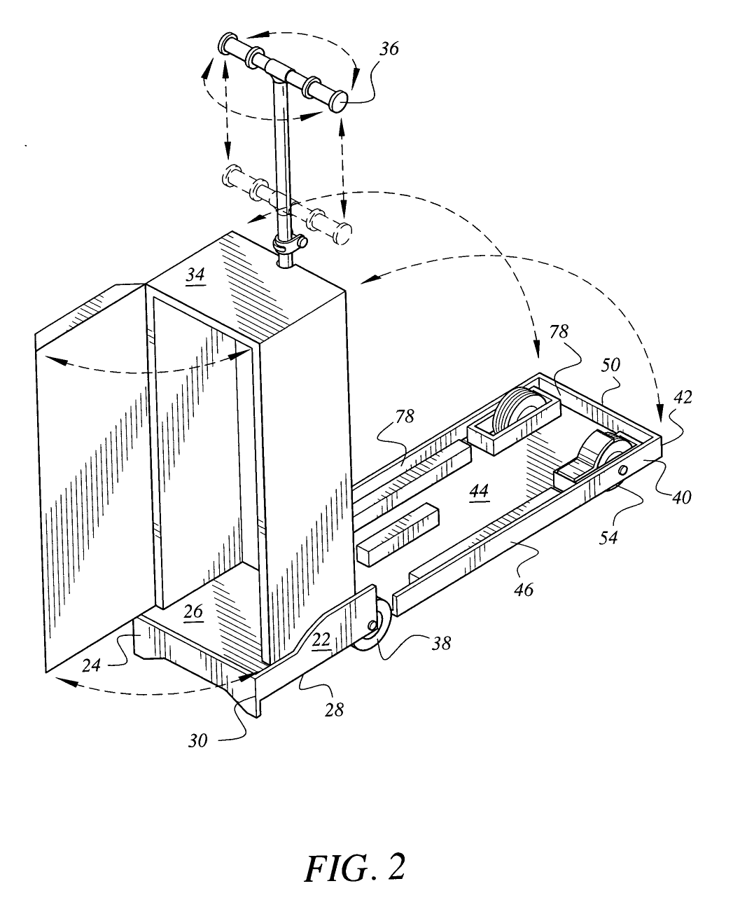

The present invention provides a baggage scooter. One of the preferred embodiments of the invention is depicted in FIGS. 1-2, and is generally referenced by numeral 20.

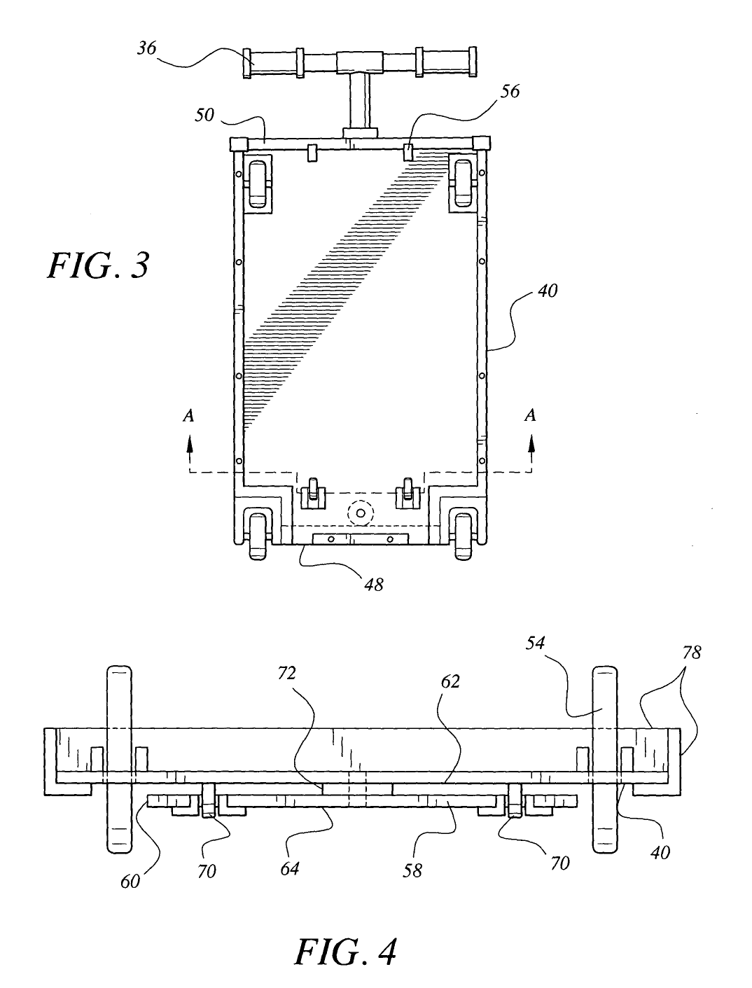

As illustrated in FIGS. 1 and 2, the baggage scooter 20 has a first plate 22 for holding a carrying case or luggage item, a second plate 40 upon which items can be carried or upon which a person can ride in a standing or other position, and a first connecting means (not shown) for adjoining the first plate 22 to the second plate 40. The first plate 22 includes a handle 36 and a first rolling means in the form of wheels 38. The second plate 40 includes a second rolling means in the form of wheels 54, and a locking means 56 (see FIG. 3). With specific reference to FIG. 2, the invention is a carry-on tote bag 34, which can be ridden as shown in FIG. 1. The baggage scooter 20 may be integrally formed with the tote bag 34 to provide a baggage item that may be ridden itself.

In its operative position, the second plate 40 will be rotated downward, and the handle 36 will be in an extended position.

The first plate 22 has an outer circumference 24, a top 26, and a bottom 28. The outer circumference 24 of the first plate 22 includes a first edge 30 and second edge (not shown). The first wheels 38 project from the bottom 28 of the first plate 22.

The handle 36 is joined to the top 26 of the first plate 22. The handle 36 is moveable between a retracted position and an extended position. In a preferred embodiment of the invention, the handle 36 is a T-type retractable handle.

The second plate 40 has an outer circumference 42, a top 44, and a bottom 46. The outer circumference 42 of the second plate 40 includes a first edge 48 and second edge 50 (see FIG. 3). The second wheels 54 project from the bottom 46 of the second plate 40. The first connecting means (not shown) rotatably adjoins the first plate 22 and the second plate 40, such that the second edge (not shown) of the first plate 22 is positioned near the first edge 48 of the second plate 40. As can be appreciated from the lower portion of FIG. 3, this connecting means can be a hinge construction.

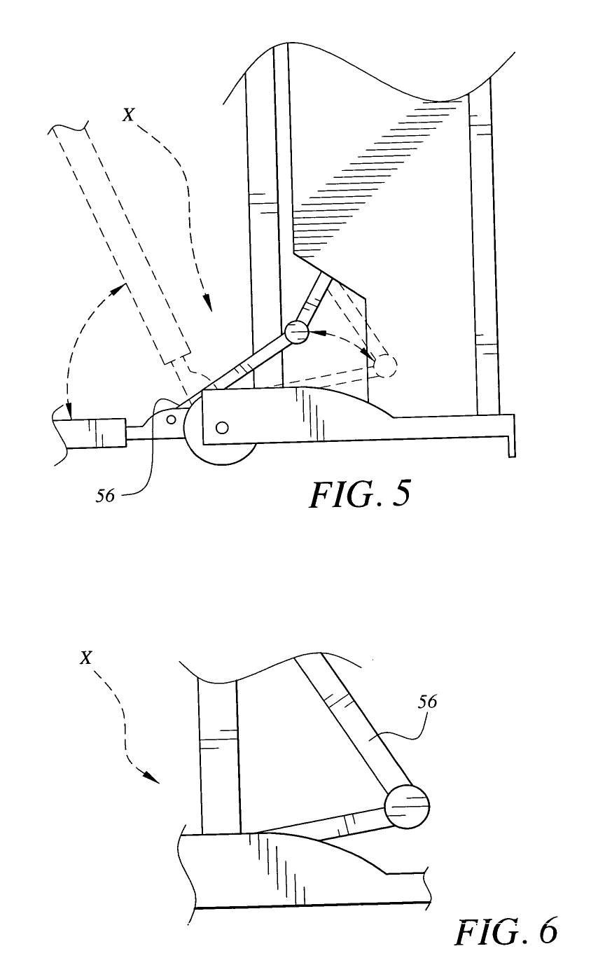

As shown in FIGS. 2, 5 and 6, an over center locking structure 56 positions the second plate 40 in an upright position for storage and an extended position during use. In a preferred embodiment of the invention, the second plate 40 will be generally parallel to the handle 36 in the upright position, and generally parallel to the ground or other supporting surface during use.

In the present embodiment of the invention, the first connecting means has a connecting plate 58, a second connecting means (not shown), and a third connecting means (not shown). The connecting plate 58 has an outer circumference 60, a top 62, and a bottom 64. The outer circumference 60 of the connecting plate 58 includes a first edge (not shown) and a second edge (not shown). The second connecting means (not shown) rotatably adjoins the first plate 22 to the connecting plate 58. The second connecting means (not shown) positions the second edge (not shown) of the first plate 22 adjacent to the first edge (not shown) of the connecting plate 58. The third connecting means (not shown) rotatably adjoins the second plate 40 to the connecting plate 58, such that the second plate 40 will be positioned to rotate in a plane generally parallel to the connecting plate 58.

In the present embodiment of the invention, the third connecting means (not shown) has a flat bearing 72 rotatably connecting the second plate 40 to the connecting plate 58, and two carrier bearings 70 projecting from the connecting plate 58 against the second plate 40. The flat bearing 72 and the two carrier bearings 70 are sized and positioned such that the second plate 40 will be positioned to rotate in a plane generally parallel to the connecting plate 58, as shown in FIGS. 3 and 4.

In the present embodiment of the invention, the first rolling means 38 includes two roller blade wheels, and the second rolling means 54 includes two roller blade wheels.

In another embodiment of the invention, the first rolling means 38 includes two wheels, and the second rolling means 54 includes one wheel.

In another embodiment of the invention, the first rolling means 38 includes one wheel, and the second rolling means 54 includes one wheel.

In an alternative embodiment of the invention, the baggage scooter 20 has a first plate 22 for holding a carrying case or luggage item, a second plate 40 upon which items can be carried or upon which a person can ride in a standing or other position, and a first connecting means (not shown) for adjoining the first plate 22 to the second plate 40. The first plate 22 includes a handle 36 and a first rolling means 38. The second plate 40 includes a locking means 56.

In another embodiment of the invention, support members 78 (shown in FIG. 2 on top 44) may be strategically adjoined to portions of the top 26 and edge 24 of the first plate 22 to add strength.

In another embodiment of the invention, support members 78 may be strategically adjoined to portions of to the top 44 and edge 42 of the second plate 40 to add strength.

In another embodiment of the invention, support members 78 may be strategically adjoined to portions of the top 26 and edge 24 of the first plate 22 and to portions of the top 44 and edge 42 of the second plate 40 to add strength.

In another embodiment of the invention, the baggage scooter 20 includes a power drive that can be used to move the invention either forward or backward, or both directions. The power drive could be a belt driving means that is powered by a battery operated motor (not shown).

In another embodiment of the invention, the first plate 22 may include a retractable luggage platform for transporting additional items.

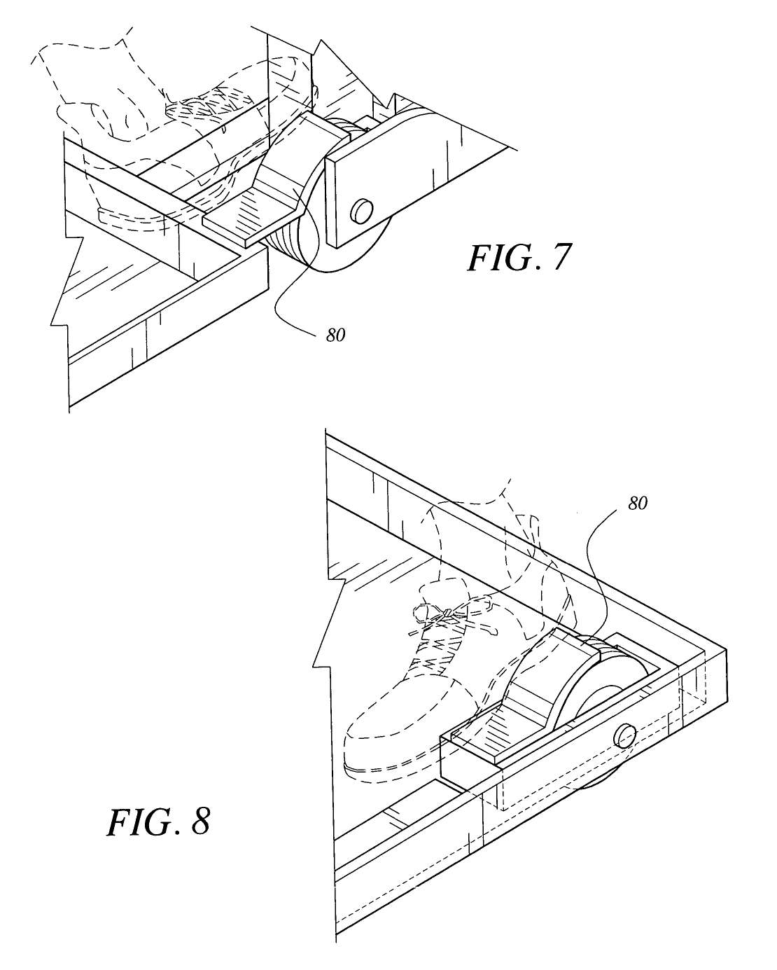

In another embodiment of the invention, the baggage scooter 20 includes a brake 80. The brake 80 may be connected to either the one of the first wheels 38, one of the second wheels 54, or both 38, 54. The brakes may be either scrub type or hand cable operated brakes, or a combination thereof. See FIGS. 7 and 8.

In alternative embodiment of the invention, the baggage scooter 29 has a selectively expandable second plate 40 that can be expanded to increase the carrying capacity of the second plate 40.

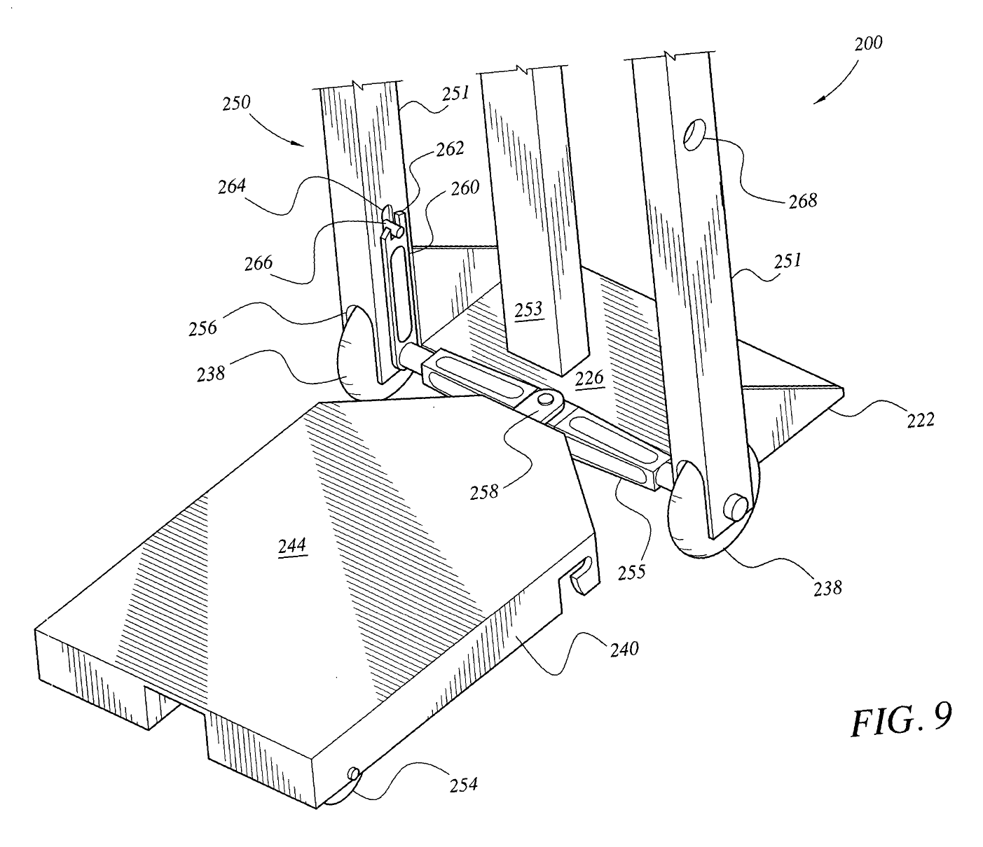

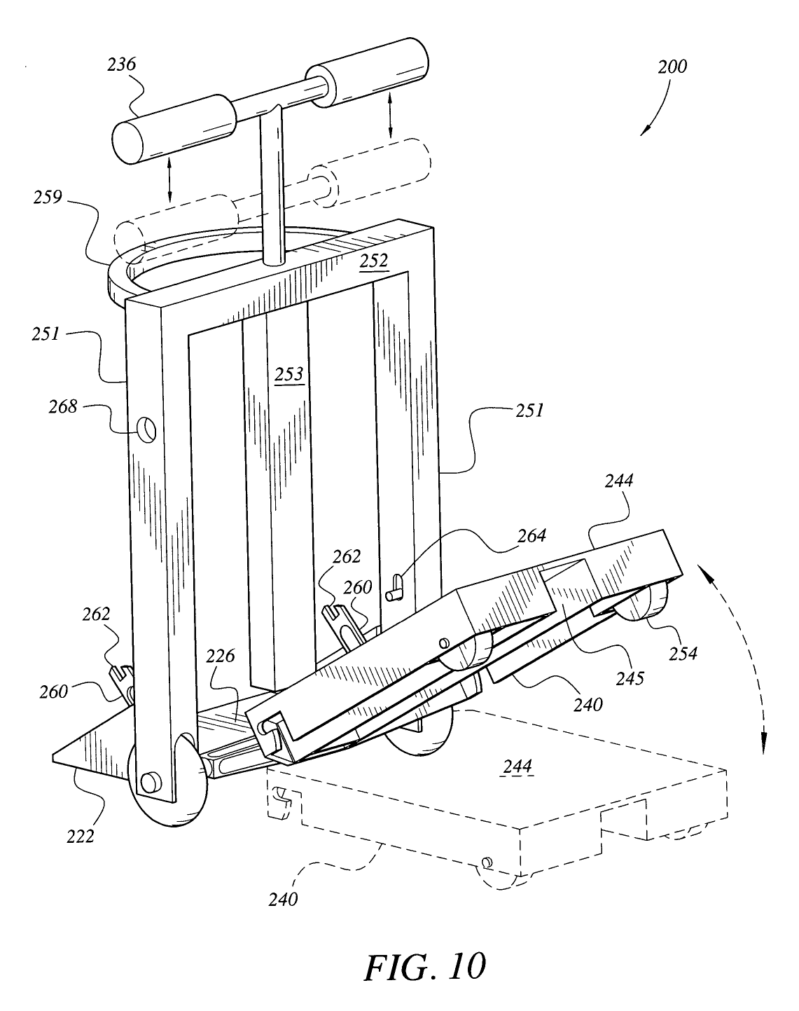

FIGS. 9 and 10 depict a preferred embodiment of the baggage scooter 200. FIG. 9 is a rear perspective view of the preferred embodiment of the baggage scooter 200 in the riding position. The baggage scooter 200 has a first plate 222 for holding a carrying case or luggage item, a second plate 240 upon which items can be carried or upon which a person can ride in a standing or other position and a frame structure 250, which the first plate 222 and the second plate 240 are secured to. The frame 250 has a pair of vertically disposed side bars 251, a vertically disposed center bar 253 and a horizontally disposed top cross bar 252. The side bars 251 each have a bottom portion 256 that is secured to a pair of wheels 238 that define a first rolling mechanism. The two wheels 238 are secured to either end of an axle 255 that is horizontally disposed between the two side bars 251.

The first plate 222 has a top surface 226 for receiving a carrying case or luggage item. The first plate 222 is secured to the bottom portion 256 of each of the side bars 251. The luggage item is placed onto the top surface 226 of the first plate 222 and is held in place by a luggage retainer 259 disposed along the top cross bar 252 (shown in FIG. 10).

The second plate 240 has a flat top surface 244 for receiving a rider or an additional piece of luggage. The second plate 240 is pivotally secured to the axle 255 by a hinge member. The hinge member is preferably a C clamp 258 that is secured to the axle by a fastener pin.

The present preferred embodiment of the baggage scooter 200 further comprises a locking member that secures the baggage scooter 200 in its riding position shown in FIG. 9. The locking mechanism comprises a pair of pivoting locking arms 260. Each locking arm 260 is positioned on the interior side of each side bar 251. Each locking arm 260 provides a fastener receiving slot 262 disposed along its top surface.

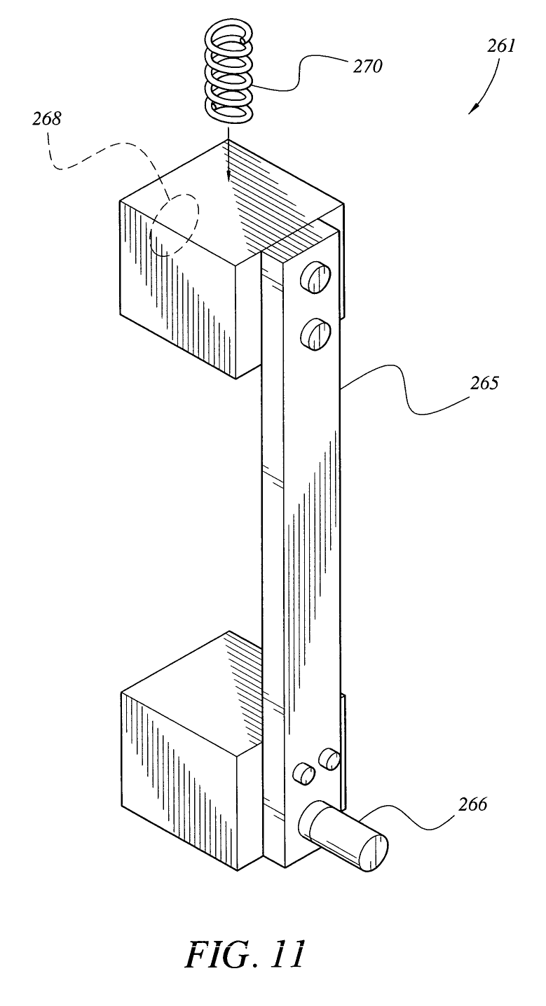

The locking mechanism further comprises a locking arm engaging device 261. FIG. 11 is a perspective view of the locking arm engaging device 261. The baggage scooter 200 provides a locking arm engaging device 261 inside of each of the side bars 251. The locking arm engaging device 261 comprises an engaging portion, a disengaging portion and a main body portion 265 that separates and supports the engaging portion and the disengaging portion. The engaging portion has a locking pin 266 that extends from the main body portion 265. The locking pin 266 extends through a hole 264 in the side bar 251 and engages the fastener receiving slot 262 of the locking arm 260. The disengaging portion provides a finger through hole 268 that extends through the outer side of the side bar 251. The finger through hole 268 is adapted to allow the user of the baggage scooter 200 to extend a finger through the hole to contact the engaging device 261.

FIG. 10 depicts the baggage scooter 200 being moved from the riding position to the carrying position by pivoting the second plate 240 to its folded upward position against the frame 250. The baggage scooter 200 is placed into the carrying position by first disengaging the locking arms 260 and them pivoting the second plate 240 about the axle 255. To unlock the locking arms 260 the user must extend a finger into each of the finger holes 268 to lift the engaging devices 261. The engaging devices 261 are biased downward, so that the locking pin 266 is forcibly engaged with the fastener receiving slot 262, by a spring 270 (shown in FIG. 11) that is positioned above the engaging device 261. The user lifts the engaging device 261 with a finger, which lifts the locking pin 266 out of engagement with the fastener receiving slot 262. This unlocks the locking arms 260 and allows them to pivot forward onto the first plate 222. The locking arms 260 and the second plate 240 simultaneously pivot forward until the baggage scooter is in the carrying position.

To place the baggage scooter 200 back into the riding position the user places a finger into each of the finger holes 268 and lifts the downwardly biased engaging devices 261. The second plate 240 and the locking arms 260 are pivoted back to the riding position (shown in FIG. 9). Once the locking arms 260 are in position underneath of the through holes 264 the user releases the engaging devices 261, which are then biased downward by the spring 270 so that the locking pins 266 engage the fastener receiving slots 262 of the locking arms 260 to secure them in place.

The C bracket 258 may optionally be designed to allow the second plate 240 to rotate as it pivots about the axle 255. This will allow the bottom of the second plate 240 to rest against the frame 250 instead of the top surface 244. This will allow the wheels 254 to be hidden from view when the baggage scooter 200 is in the carrying position. The second plate 240 has a channel 245 that is adapted to fit around the center bar 253 so the plate 240 will rest evenly against the frame 250.

As shown in FIG. 2, the carry-on bag 34 may be integrally formed to the baggage scooter 20. This provides an actual baggage item that includes a scooter assembly so that the baggage 34 itself may be ridden or carried. As shown in FIG. 9, however, the baggage scooter 200 may be formed separately from the baggage 34 to provide a baggage scooter 200 that may carry baggage items or other items as well on its first plate 222.

It is to be understood that the present invention is not limited to the embodiments described above, but encompasses any and all embodiments within the scope of the following claims.

We claim:

1. A baggage scooter comprising:
a baggage item;
a first plate for holding said baggage item, the plate having an outer circumference, a top, and a bottom, the outer circumference having a first edge and a second edge;
a second plate having an outer circumference, a top and a bottom, the outer circumference having a first edge and a second edge;
a connecting member pivotally joining the first plate to the second plate, wherein the second edge of the first plate is positioned near the first edge of the second plate;
a retractable handle member attached to the first plate;
a first rolling means disposed along the bottom of the first plate;
a second rolling means disposed along the bottom of the second plate; and
a locking member for securing the second plate in a riding position;
whereby the second plate is pivotal from a horizontal riding position to a vertical stored, carrying position.

2. The baggage scooter according to claim 1, further comprising a frame portion extending vertically from said connecting means for supporting said second plate in its stored position, said frame having a pair of vertically oriented side bars and a horizontally oriented top cross bar disposed across said side bars.

3. The baggage scooter according to claim 1, wherein said handle is a T-shaped handle.

4. The baggage scooter according to claim 1, wherein said handle is joined to the top of said first plate.

5. The baggage scooter according to claim 2, wherein said handle is joined to the top of said frame.

6. The baggage scooter according to claim 1, wherein said first rolling means comprises at least one wheel.

7. The baggage scooter according to claim 1, wherein said second rolling means comprises at least one wheel.

8. The baggage scooter according to claim 7, wherein said first rolling means and said second rolling means each comprise two wheels.

9. The baggage scooter according to claim 8, wherein said first rolling means and said second rolling means each comprise two roller blade wheels.

10. The baggage scooter according to claim 1, wherein said connector means comprises a connector plate having an outer circumference, a top and a bottom.

11. The baggage scooter according to claim 1, wherein said connector means comprises an axle that is secured between to the first rolling means and a hinge that pivotally secures said second plate to said axle.

12. The baggage scooter according to claim 1, wherein said baggage item is integrally formed to said first plate so that said baggage item may be ridden itself.

13. The baggage scooter according to claim 2, wherein said locking member comprises:
a pair of pivoting locking arms positioned on an inner side of said side bars, each locking arm having a fastener receiving slot;
a pin receiving hole disposed on the inner side of each of said side bars;
a finger receiving hole disposed on an outer side of each of said side bars;
a engaging device disposed inside of each of said side bars having a main body portion with a top end and a bottom end and a locking pin for engaging said fastener receiving hole disposed along the bottom end; and
a spring positioned above the top end of said engaging device for downwardly biasing said engaging device into engagement with said locking arms by positioning said locking pin inside of said fastener receiving slot.

14. The baggage scooter according to claim 1, further comprising support members attached to said first and second plates for adding strength to the baggage scooter.

15. The baggage scooter according to claim 1, further comprising a brake secured to at least one of said rolling means.

16. The baggage scooter according to claim 15, wherein said brake is selected from the group consisting of said scrub type brakes, hand cable operated brakes, and a combination of scrub type brakes and hand cable operated brakes.

17. The baggage scooter according to claim 1, wherein said baggage item is integrally formed to said frame portion so that said baggage item may be ridden itself.

18. A baggage scooter comprising:
a first plate, for holding a baggage item, having an outer circumference, a top, and a bottom, the outer circumference having a first edge and a second edge;
a second plate having an outer circumference, a top and a bottom, the outer circumference having a first edge and a second edge;
a support frame having a pair of vertically oriented side bars having a top end and a bottom end and a horizontally oriented top cross bar disposed across the top end of said side bars;
a pair of wheels disposed along the bottom end of each of said side bars defining a first rolling mechanism;
an axle secured between said pair of wheels;
a second rolling mechanism disposed along the bottom of said second plate having at least one wheel;
a retractable handle portion extending from said top cross bar;
a connector member for pivotally securing said second plate to said axle;
a generally U-shaped baggage retainer bar horizontally extending from said top cross bar for securing the baggage on said first plate; and
a locking member for securing said second plate in a riding position;
whereby said second plate is pivotal from a horizontal riding position to a vertical stored, carrying position.

19. The baggage scooter according to claim 18, wherein said locking member comprises:
a pair of pivoting locking arms positioned on an inner side of said side bars, each locking arm having a fastener receiving slot;
a pin receiving hole disposed on the inner side of each of said side bars;
a finger receiving hole disposed on an outer side of each of said side bars;
a engaging device disposed inside of each of said side bars having a main body portion with a top end and a bottom end and a locking pin for engaging said fastener receiving hole disposed along the bottom end; and
a spring positioned above the top end of said engaging device for downwardly biasing said engaging device into engagement with said locking arms by positioning said locking pin inside of said fastener receiving slot.

20. The baggage scooter according to claim 18, wherein said connector member is a C-shaped clamp disposed on said second plate, the clamp further comprising a fastening pin pivotally securing the clamp to said axle.
